(19) United States
(12) Patent Application Publication
(10) Pub. No.: US 2014/0019125 A1
(43) Pub. Date: Jan. 16, 2014

(54) LOW BAND BANDWIDTH EXTENDED

(71) Applicants: Laura Laaksonen, Espoo (FI); Hannu Juhani Pulakka, Espoo (FI); Ulpu Remes, Espoo (FI); Paavo Ilmari Alku, Helsinki (FI); Kalle Palomaki, Vantaa (FI)

(72) Inventors: Laura Laaksonen, Espoo (FI); Hannu Juhani Pulakka, Espoo (FI); Ulpu Remes, Espoo (FI); Paavo Ilmari Alku, Helsinki (FI); Kalle Palomaki, Vantaa (FI)

(73) Assignee: Nokia Corporation, Espoo (FI)

(21) Appl. No.: 14/006,154

(22) PCT Filed: Mar. 31, 2011
(86) PCT No.: PCT/IB2011/051391

§ 371 Date: Sep. 19, 2013

(51) Int. Cl. G10L 19/02

(52) U.S. Cl. CPC G10L 19/02
USPC 704/205

(57) ABSTRACT

Apparatus comprising: an input amplitude and phase calculator configured to determine at least one amplitude value and phase value dependent on a first audio signal; a synthesis amplitude calculator configured to synthesize a further amplitude value associated with each amplitude value dependent on a determined harmonic shaping function; a synthesis phase calculator configured to synthesize a further phase value associated with each phase value; and a signal synthesizer configured to generate a bandwidth extension signal dependent the further amplitude value and the further phase values.

### FIELD OF THE APPLICATION

The present invention relates to an apparatus and method for improving the quality of an audio signal. In particular, the present invention relates to an apparatus and method for extending the bandwidth of an audio signal.

### BACKGROUND OF THE APPLICATION

Audio signals, such as speech or music, can be encoded to enable efficient transmission or storage of the audio signals. The audio signal can be received or retrieved, decoded and presented to a user.

Audio signals can be limited to a bandwidth which is typically determined by the available capacity of the transmission system or storage medium. However, in some instances it may be desirable to perceive or present the decoded audio signal at a wider bandwidth than the bandwidth at which the audio signal was originally encoded. In these instances artificial bandwidth extension may be deployed at the decoder, whereby the bandwidth of the decoded audio signal may be extended by using information solely determined from the decoded audio signal itself.

The audio bandwidth of 300 Hz to 3400 Hz which is used in today's fixed and mobile communication systems is comparable to that of conventional analogue telephony. This is because when digital standards were first established, a common audio bandwidth facilitated interoperability between the analogue and digital domains. This common narrowband signal is known as the telephone band.

These artificial bandwidth extensions can be higher or high frequency band (HB) extensions for example extending the output to 8 kHz and lower or low frequency band (LB) extensions for example extending the output to 50 Hz.

The capture and reproduction of frequencies below this range can often be limited by the characteristics of the terminal devices and by the filtering applied to the signal prior to encoding. However, human voice often contains frequency components below the telephone bandwidth. Consequently the quality of speech and the naturalness of the speech can be degraded by the limited frequency range. Artificial bandwidth extension (ABE) techniques have been proposed in which an extension band below the frequency range of the telephone band or narrowband signal called the low band which can, for example range from 50 Hz to 300 Hz is estimated from a received or recovered narrowband audio signal.

Current artificial bandwidth extension methods are known to apply, the low band or lower extension band (from 50 Hz to 300 Hz), irrelevant of whether or not it can improve the audio signal.

The embodiments of the application attempt to improve the perceived quality and intelligibility of the narrowband telephone speech by post-processing the speech signal received or recovered and by artificially widening the low frequency content below the telephone band, based solely on information extracted from the received speech signal when the sound reproduction system is capable of reproducing low frequencies. This can be employed in embodiments in a mobile terminal or in some other speech communication device or software, such as a teleconferencing system, or an ambient telephony system.

### SUMMARY OF SOME EMBODIMENTS

Embodiments aim to address the above problem.

There is provided according to a first aspect a method comprising: determining at least one amplitude value and phase value dependent on a first audio signal; synthesising a further amplitude value associated with each amplitude value dependent on a determined harmonic shaping function; synthesising a further phase value associated with each phase value; and generating a bandwidth extension signal dependent the further amplitude value and the further phase values.

The method may further comprise generating at least one attenuation factor, wherein the bandwidth extension signal may be further dependent on the attenuation factor.

The at least one attenuation factor may comprise an unvoiced signal attenuation factor, the unvoiced signal attenuation factor being dependent on an unvoiced component of the first audio signal.

The at least one attenuation factor may comprise a pause attenuation factor, the pause attenuation factor being dependent on determining a paused speech component of the first audio signal.

The at least one attenuation factor may comprise a fundamental frequency attenuation factor, the fundamental frequency attenuation factor being dependent on a fundamental frequency estimate associated with the first audio signal.

The at least one attenuation factor may comprise an octave error attenuation factor, the octave error attenuation factor being dependent on determining an error in a fundamental frequency estimate associated with the first audio signal.

The method may further comprise determining a harmonic shaping function dependent on the estimated bandwidth extension signal energy level.

The method may further comprise determining an estimated bandwidth extension signal energy level.

Determining an estimated bandwidth extension signal energy level may comprise: determining at least one feature value associated with the first signal; and applying the at least one feature to a trained modelling function to determine the estimated bandwidth extension signal energy level.

The modelling function may comprise at least one of: a Gaussian mixture model; a hidden Markov model; and a neural network model.

Synthesising the further amplitude value associated with each amplitude value may be further dependent on the first audio signal.

Synthesising the further amplitude value associated with each amplitude value to be further dependent on the first audio signal may comprise: determining the amplitudes of the first audio signal for the harmonic frequencies associated with the first amplitude; and synthesising the further amplitude dependent on the amplitudes of the first audio signal for the harmonic frequencies associated with the first amplitude.

Synthesising a further phase value associated with each phase value may comprise: determining a condition associated with each phase value; and generating a further phase value dependent on the condition and the phase value.

Determining the condition associated with the phase value may comprise: determining the phase value is highly varying, wherein the further phase value is a reference phase value; determining the onset of the phase value, wherein the further phase value is the reference phase value; determining the phase value is sufficiently close to the reference phase value, wherein the further phase value is the phase value; determining the phase value is different from the reference phase value and the phase value is consistent over a period of time, wherein the further phase value is phase value approaching the phase value from the reference phase value; and otherwise determining the phase value is inconsistent over a period of time, wherein the further phase value is the reference phase value.

The reference phase value may be dependent on a previous period further phase value and the fundamental frequency estimates from the current and previous periods.

According to a second aspect there is provided an apparatus comprising at least one processor and at least one memory including computer code, the at least one memory and the computer code configured to with the at least one processor cause the apparatus to at least perform: determining at least one amplitude value and phase value dependent on a first audio signal; synthesising a further amplitude value associated with each amplitude value dependent on a determined harmonic shaping function; synthesising a further phase value associated with each phase value; and generating a bandwidth extension signal dependent the further amplitude value and the further phase values.

The apparatus may be further configured to perform generating at least one attenuation factor, wherein the bandwidth extension signal is further dependent on the attenuation factor.

The at least one attenuation factor may comprise an unvoiced signal attenuation factor, the unvoiced signal attenuation factor being dependent on an unvoiced component of the first audio signal.

The at least one attenuation factor may comprise a pause attenuation factor, the pause attenuation factor being dependent on determining a paused speech component of the first audio signal.

The at least one attenuation factor may comprise a fundamental frequency attenuation factor, the fundamental frequency attenuation factor being dependent on a fundamental frequency estimate associated with the first audio signal.

The at least one attenuation factor may comprise an octave error attenuation factor, the octave error attenuation factor being dependent on determining an error in a fundamental frequency estimate associated with the first audio signal.

The apparatus may be further configured to perform determining a harmonic shaping function dependent on the estimated bandwidth extension signal energy level.

The apparatus may be further configured to perform determining an estimated bandwidth extension signal energy level.

Determining an estimated bandwidth extension signal energy level may cause the apparatus to further perform: determining at least one feature value associated with the first signal; and applying the at least one feature to a trained modelling function to determine the estimated bandwidth extension signal energy level.

The modelling function may comprise at least one of: a Gaussian mixture model; a hidden Markov model; and a neural network model.

Synthesising the further amplitude value associated with each amplitude value may be further dependent on the first audio signal.

Synthesising the further amplitude value associated with each amplitude value further dependent on the first audio signal further may cause the apparatus to perform: determining the amplitudes of the first audio signal for the harmonic frequencies associated with the first amplitude; and synthesising the further amplitude dependent on the amplitudes of the first audio signal for the harmonic frequencies associated with the first amplitude.

Synthesising a further phase value associated with each phase value may cause the apparatus to perform: determining a condition associated with each phase value; and generating a further phase value dependent on the condition and the phase value.

Determining the condition associated with the phase value may cause the apparatus to further perform: determining the phase value is highly varying, wherein the further phase value is a reference phase value; determining the onset of the phase value, wherein the further phase value is the reference phase value; determining the phase value is sufficiently close to the reference phase value, wherein the further phase value is the phase value; determining the phase value is different from the reference phase value and the phase value is consistent over a period of time, wherein the further phase value is phase value approaching the phase value from the reference phase value; and otherwise determining the phase value is inconsistent over a period of time, wherein the further phase value is the reference phase value.

The reference phase value may be dependent on a previous period further phase value and the fundamental frequency estimates from the current and previous periods.

According to a third aspect there is provided apparatus comprising: means for determining at least one amplitude value and phase value dependent on a first audio signal; means for synthesising a further amplitude value associated with each amplitude value dependent on a determined harmonic shaping function; means for synthesising a further phase value associated with each phase value; and means for generating a bandwidth extension signal dependent the further amplitude value and the further phase values.

The apparatus may further comprise means for generating at least one attenuation factor, wherein the bandwidth extension signal is further dependent on the attenuation factor.

The at least one attenuation factor may comprise an unvoiced signal attenuation factor, the unvoiced signal attenuation factor being dependent on an unvoiced component of the first audio signal.

The at least one attenuation factor may comprise a pause attenuation factor, the pause attenuation factor being dependent on determining a paused speech component of the first audio signal.

The at least one attenuation factor may comprise a fundamental frequency attenuation factor, the fundamental frequency attenuation factor being dependent on a fundamental frequency estimate associated with the first audio signal.

The at least one attenuation factor may comprise an octave error attenuation factor, the octave error attenuation factor being dependent on determining an error in a fundamental frequency estimate associated with the first audio signal.

The apparatus may further comprise means for determining a harmonic shaping function dependent on the estimated bandwidth extension signal energy level.

The apparatus may further comprise means for determining an estimated bandwidth extension signal energy level.

The means for determining an estimated bandwidth extension signal energy level may comprise: means for determining at least one feature value associated with the first signal; and means for applying the at least one feature to a trained modelling function to determine the estimated bandwidth extension signal energy level.

The modelling function may comprise at least one of: a Gaussian mixture model; a hidden Markov model; and a neural network model.

The means for synthesising the further amplitude value associated with each amplitude value may be further dependent on the first audio signal.

The means for synthesising the further amplitude value associated with each amplitude value further dependent on the first audio signal may further comprise:

means for determining the amplitudes of the first audio signal for the harmonic frequencies associated with the first amplitude; and means for synthesising the further amplitude dependent on the amplitudes of the first audio signal for the harmonic frequencies associated with the first amplitude.

The means for synthesising a further phase value associated with each phase value may comprise: means for determining a condition associated with each phase value; and means for generating a further phase value dependent on the condition and the phase value.

The means for determining the condition associated with the phase value may comprise: means for determining the phase value is highly varying, wherein the further phase value is a reference phase value; means for determining the onset of the phase value, wherein the further phase value is the reference phase value; means for determining the phase value is sufficiently close to the reference phase value, wherein the further phase value is the phase value; means for determining the phase value is different from the reference phase value and the phase value is consistent over a period of time, wherein the further phase value is phase value approaching the phase value from the reference phase value; and means for determining the phase value is inconsistent over a period of time, wherein the further phase value is the reference phase value.

The reference phase value may be dependent on a previous period further phase value and the fundamental frequency estimates from the current and previous periods.

According to a fourth aspect there is provided apparatus comprising: an input amplitude and phase calculator configured to determine at least one amplitude value and phase value dependent on a first audio signal; a synthesis amplitude calculator configured to synthesize a further amplitude value associated with each amplitude value dependent on a determined harmonic shaping function; a synthesis phase calculator configured to synthesize a further phase value associated with each phase value; and a signal synthesizer configured to generate a bandwidth extension signal dependent the further amplitude value and the further phase values.

The apparatus may further comprising an attenuator gain determiner configured to generate at least one attenuation factor, wherein the bandwidth extension signal is further dependent on the attenuation factor.

The at least one attenuation factor may comprise an unvoiced signal attenuation factor, the unvoiced signal attenuation factor being dependent on an unvoiced component of the first audio signal.

The at least one attenuation factor may comprise a pause attenuation factor, the pause attenuation factor being dependent on determining a paused speech component of the first audio signal.

The at least one attenuation factor may comprise a fundamental frequency attenuation factor, the fundamental frequency attenuation factor being dependent on a fundamental frequency estimate associated with the first audio signal.

The at least one attenuation factor may comprise an octave error attenuation factor, the octave error attenuation factor being dependent on determining an error in a fundamental frequency estimate associated with the first audio signal.

The apparatus may further comprise a harmonic amplitude estimator configured to perform determining a harmonic shaping function dependent on the estimated bandwidth extension signal energy level.

The apparatus may further comprise a lowband energy estimator configured to determine an estimated bandwidth extension signal energy level.

The lowband energy estimator may comprise: a feature determiner configured to determine at least one feature value associated with the first signal; and a trained modelling function configured to determine the estimated bandwidth extension signal energy level dependent on the at least one feature value.

The trained modelling function may comprise at least one of: a Gaussian mixture model; a hidden Markov model; and a neural network model.

The signal synthesizer configured to generate a bandwidth extension signal may be further dependent on the first audio signal.

The signal synthesizer configured to generate a bandwidth extension signal may further comprise: an amplitude determiner configured to determine the amplitudes of the first audio signal for the harmonic frequencies associated with the first amplitude; and wherein the synthesizer being configured to determine the further amplitude dependent on the amplitudes of the first audio signal for the harmonic frequencies associated with the first amplitude.

The synthesis phase calculator may comprise: a condition determiner configured to determine a condition associated with each phase value; a phase synthesizer configured to generate the further phase value dependent on the condition and the phase value.

The condition determiner may comprise: a first condition determiner configured to determine the phase value is highly varying, wherein the further phase value is a reference phase value; a second condition determiner configured to determine an onset of the phase value, wherein the further phase value is the reference phase value; a third condition determiner configured to determine the phase value is sufficiently close to the reference phase value, wherein the further phase value is the phase value; a fourth condition determiner configured to determine the phase value is different from the reference phase value and the phase value is consistent over a period of time, wherein the further phase value is phase value approaching the phase value from the reference phase value; and a fifth condition determiner configured to determine the phase value is inconsistent over a period of time, wherein the further phase value is the reference phase value.

The reference phase value may be dependent on a previous period further phase value and the fundamental frequency estimates from the current and previous periods.

An electronic device may comprise apparatus as described herein. A chipset may comprise apparatus as described herein.

### BRIEF DESCRIPTION OF DRAWINGS

For better understanding of the present invention, reference will now be made by way of example to the accompanying drawings in which:

FIG. 1 shows schematically an electronic device employing embodiments of the invention;

FIG. 2 shows schematically a decoder system employing embodiments of the invention;

FIG. 3 shows schematically a decoder according to some embodiments of the application;

FIG. 4 shows a flow diagram detailing the operation of the decoder shown in FIG. 3;

FIG. 5 shows relative performance for narrowband, adaptive multi rate-wide band, high band artificial bandwidth extension, and low band+high band artificial bandwidth extension for a voiced male speech short segment example;

FIG. 6 shows relative performance for narrowband, adaptive multi rate-wide band, and low band extension+narrow band for a voiced male speech example; and

FIG. 7 shows a further example of the relative performance characteristics in long-term average spectra shown by narrowband, adaptive multi-rate wideband speech coding, and artificial bandwidth extension decoding.

### DESCRIPTION OF SOME EMBODIMENTS OF THE APPLICATION

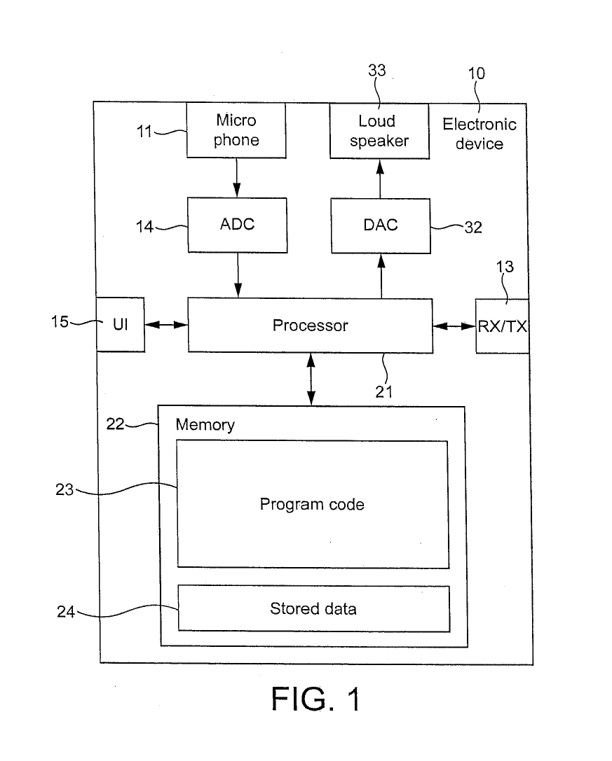

The following describes in more detail possible mechanisms for the provision of artificially expanding the bandwidth of a decoded audio signal. In this regard reference is first made to FIG. 1 which shows a schematic block diagram of an exemplary electronic device 10 or apparatus, which may incorporate an artificial bandwidth extension system according to some embodiments.

The electronic device or apparatus 10 can for example be as described herein a mobile terminal or user equipment of a wireless communication system. In some other embodiments the apparatus 10 can be any suitable audio or audio-subsystem component within an electronic device such as audio player (also known as MP3 players) or media players (also known as MP4 players). In some other embodiments, the electronic device can be a teleconference terminal or ambient telephone terminal.

The electronic device 10 can comprise in some embodiments a microphone 11, which is linked via an analogue-to-digital converter (ADC) 14 to a processor 21.

The processor 21 is further linked in some embodiments via a digital-to-analogue converter (DAC) 32 to loudspeaker(s) 33. The processor 21 is in some embodiments further linked to a transceiver (RX/TX) 13, to a user interface (UI) 15 and to a memory 22.

The processor 21 can be in some embodiments configured to execute various program codes. The implemented program codes 23 can comprise an audio decoding code or speech decoding code implementing an artificial bandwidth extension code. The implemented program codes 23 can in some embodiments be stored for example in the memory 22 for retrieval by the processor 21 whenever needed. The memory 22 could further provide a section 24 for storing data, for example data that has been encoded in accordance with the application.

The decoding code can in some embodiments be implemented in electronic based hardware or firmware.

In some embodiments the device can comprise a user interface 15. The user interface 15 enables a user to input commands to the electronic device 10, for example via a keypad, and/or to obtain information from the electronic device 110, for example via a display.

Furthermore in some embodiments the electronic device further comprises a transceiver 13. The transceiver 13 enables a communication with other electronic devices, for example via a wireless communication network.

It is to be understood that the structure of the electronic device 10 could be supplemented and varied in many ways.

The electronic device 10 can in some embodiments receive a bit stream with suitably encoded data from another electronic device via its transceiver 13.

Alternatively, coded data could be stored in the data section 24 of the memory 22, for instance for a later presentation by the same electronic device 10. In both cases, the processor 21 may execute the decoding program code stored in the memory 22.

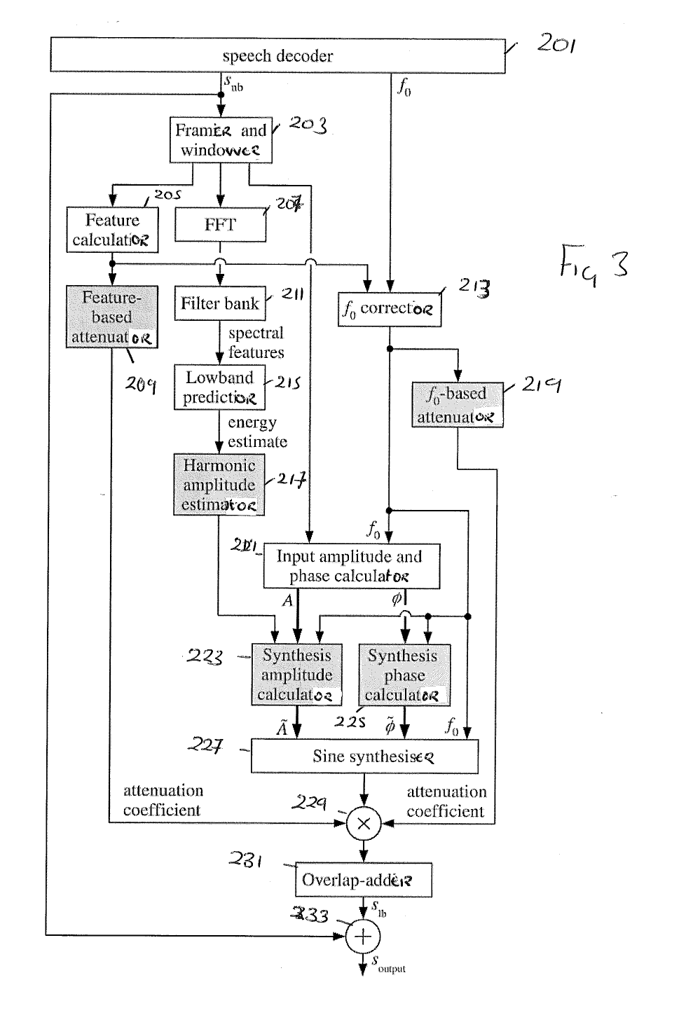

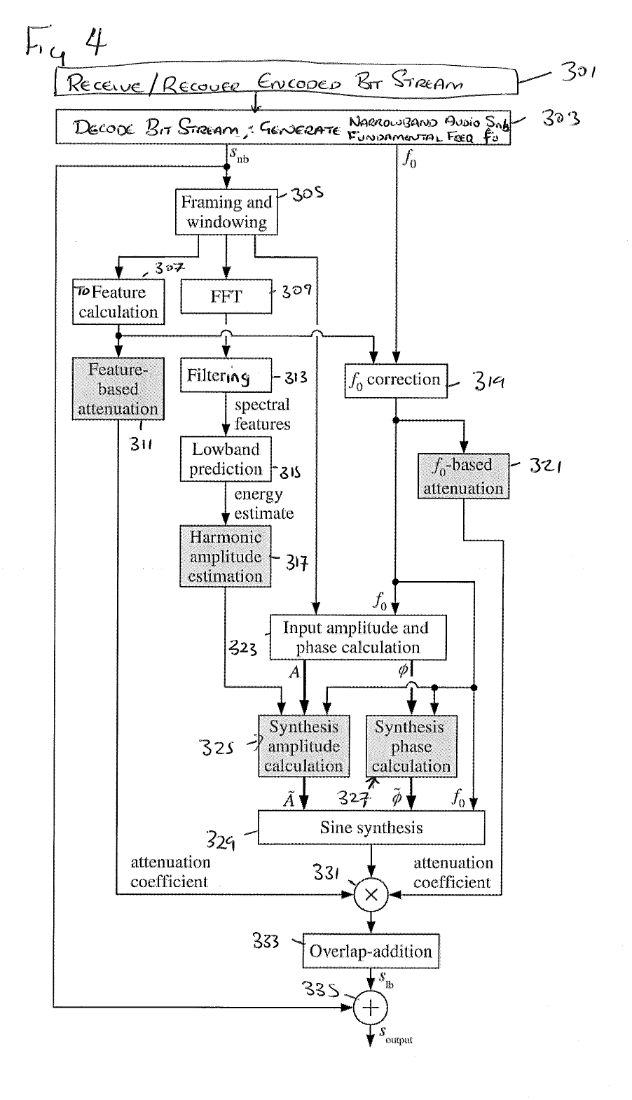

The processor 21 can therefore in some embodiments decode the received data, for instance in the manner as described with reference to FIGS. 3 and 4, and provide the decoded data to the digital-to-analogue converter 32. The digital-to-analogue converter 32 can then in some embodiments convert the digital decoded data into analogue audio data and output the audio signal via the loudspeaker(s) 33. However it would be understood that the loudspeaker or loudspeakers 33 can in some embodiments be any suitable audio transducer converting electrical signals into presentable acoustic signals.

Execution of the decoding program code could in some embodiments be triggered by an application that has been called by the user via the user interface 15.

The received encoded data could also be stored instead of an immediate presentation via the loudspeaker(s) 33 in the data section 24 of the memory 22, for instance for enabling a later presentation or a forwarding to still further electronic device.

It would be appreciated that the schematic structures described in FIG. 3 and the method steps in FIG. 4 represent only a part of the operation of a decoder and artificial bandwidth extender as exemplarily shown implemented in the electronic device shown in FIG. 1.

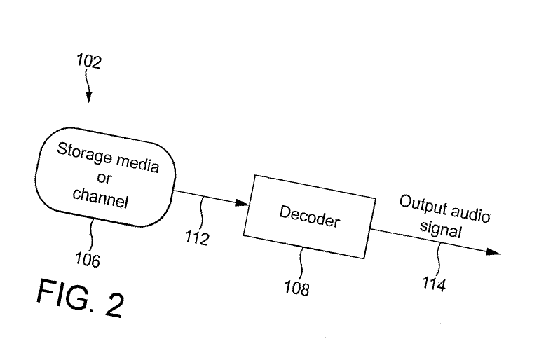

Embodiments of the application are now described in more detail with respect to FIGS. 2 to 7.

The general operation of speech and audio decoders as employed by embodiments of the application is shown in FIG. 2. A general decoding system 102 is illustrated schematically in FIG. 2. The system 102 may comprise a storage or media channel (also known as a communication channel) 106 and a decoder 108.

The decoder 108 decompresses the bit stream 112 and produces an output audio signal 114. The bit rate of the bit stream 112 and the quality of the output audio signal 114 in relation to the input signal 110 are the main features, which define the performance of the coding system 102.

The operation of speech and audio codecs are known from the art and features of such codecs which do not assist in the understanding of the operation of the embodiments of the application are not described in detail.

FIG. 3 shows schematically a decoder 108 according to some embodiments of the application. Although the term decoder has been used with respect to the process of decoding the stored/received signal and generating the artificial bandwidth extension it would be understood that these functions could in some embodiments be divided into components which decode the signal and provide decoded values such as described hereafter as the speech decoder and components which receive the decoded values and generate an artificial bandwidth extension to be combined with at least part of the decoded signal to form a wideband audio/speech signal. In other words in some embodiments an artificial bandwidth extension generator can comprise the decoder as described hereafter except the speech decoder. In such embodiments the artificial bandwidth extension generator can be configured to receive at least a narrowband signal as an input, and can furthermore optionally receive the fundamental frequency estimate. These narrowband signal and optionally the fundamental frequency estimate can be received in some embodiments from a speech decoder or any other suitable source.

The decoder 108 in some embodiments comprises a speech decoder 201. The speech decoder in some embodiments receives the encoded bit stream via a receiver. In some other embodiments the speech decoder can retrieve or recover the encoded bit stream from the memory of the electronic apparatus 10.

The operation of receiving or recovering the encoded bit stream is shown in FIG. 4 by step 301.

The speech decoder can be any suitable speech decoder, for example the adaptive multi rate (AMR) speech coding standard, details of which can be found in the 3GPP TS 26.090 Technical Specification. However in other embodiments of the application, any suitable speech or audio codec decoding algorithm can be implemented to decode the encoded bit stream.

The decoder can in some embodiments generate the narrowband audio or speech signal s_{nb} from the encoded bit stream. Furthermore in some embodiments the decoder or speech decoder 201 can be configured to further generate or determine the fundamental frequency. The speech decoder 201 can furthermore generate or recover a fundamental frequency f₀ value or pitch estimate based on a pitch period estimate performed in the associated encoder and passed along with the encoded narrowband signal. However in some embodiments the fundamental frequency can be estimated from the narrowband signal input to the bandwidth extension components as discussed herein.

The decoding of the bit stream, which can generate values for the fundamental frequency estimate f₀ and also output a narrowband audio or speech signal s_{nb} is shown in FIG. 4 by step 303.

In some embodiments the decoder 108 can further comprise a framer and windower 203. The framer and windower 203 can be configured in some embodiments to receive the narrowband audio or speech signal s_{nb} sample values and output a series of windowed time frame sampled data. In the following example the framer and windower 203 can be configured to output three differently windowed and framed audio signal outputs, however in some embodiments any suitable number of frame formats can be output. For example in some embodiments the input or decoded narrowband (telephone) speech signal s_{nb} is sampled at 8 kHz and has frames of 5 ms. However any suitable input sample rate and frame length can be processed in some embodiments. The framer and windower 203 can in some embodiments process the input decoded narrowband audio/speech signal using window functions and window lengths to generate various outputs for at least one analysis or component. The following frame formats are examples of the possible suitable framing and windowing operations.

For example in some embodiments the framer and windower 203 can perform a first framing and windowing to generate a time domain analysis frame format for a time domain feature calculator 205. In such embodiments the time domain frame format can implement a rectangular window of 20 ms onto the input signal and generate an output frame with a frame shift of 5 ms. The framer and windower 203 can using the example input signal described above concatenate four input frames each of 5 ms to generate a 20 ms frame. The framer and windower can be configured to output the time domain frame format data to the time domain feature calculator 205.

In some embodiments a second windowing and framing operation can be performed by the framer and windower 203 to generate a frequency domain analysis frame format for frequency domain analysis. For example in some embodiments the framer and windower 203 can be configured to output to a Fast Fourier Transformer 207, the narrowband signal with a 16 ms Hamming window computed for every 10 ms. However it would be possible to employ 5 ms frame shifting in some embodiments.

Furthermore in some embodiments the framer and windower 203 can be configured to output a third framing and windowing operation for generate a low band analysis frame format for low band amplitude and phase analysis. For example the third framing and windowing operation can be to generate a 20 ms Hann window computed every 5 ms.

In such embodiments the maximum look ahead used in the framer and windower 203 is 5 ms.

The operation of framing and windowing is shown in FIG. 4 by step 305.

In some embodiments the decoder 108 further comprises a time domain feature calculator 205 or feature calculator. The feature calculator 205 can, as described previously, be configured to receive frames or segments of 20 ms narrowband speech or audio signals s_{nb} with frame shifting of 5 ms. The time domain feature calculator 205 can then determine or generate from each windowed frame at least one of the following feature or characteristic values of the narrowband audio or speech signal.

### Frame Energy

The frame energy E_{dB} of the input signal s_{nb} for each frame can be computed and converted to a decibel scale using the following equation:

$${E}_{d B} = 10 {log}_{10} ( {\sum }_{k = 0}^{{N}_{k} - 1} {{S}_{nb} ( k )}^{2} ) ,$$

where k is the time index within the frame, Nₖ is the frame length, and s_{nb} is the narrowband input signal.

### Noise Floor Estimate

The noise floor estimate N_{dB}(n) for the frame n can be determined such that it approximates the lowest frame energy value. For example in some embodiments the noise floor estimate can be computed from the frame energy value by filtering the frame energy value E_{dB(n)} with a first order recursive filter such as:

N_{dB}(n)=αₙE_{dB}(n)+(1−αₙ)N_{dB}(n−1),

where αₙ=0.0015 for an upward change and αₙ=0.2 for a downward change. The noise floor estimate thus rises slowing during speech but quickly approaches energy minima. In such embodiments the value of the noise floor estimate N_{dB}(n) can in some embodiments be configured to be not allowed to go below a fixed low limit.

### Active Speech Level

The active speech level estimate S_{dB}(n) furthermore approximates a typical maximum value of the frame energy in the input signal. In a manner similar to the noise floor estimate, the active speech level estimate can be determined in some embodiments by a first order recursive filter arrangement such as:

S_{db}(n)=αₛE_{dB}(n)+(1−αₛ)S_{dB}(n−1),

where αₛ=0.2 for upward change and αₛ=0.0005 for downward change. The speech level estimate thus decays slowly during pauses but quickly approaches the energy maxima during active speech. Furthermore in such embodiments the value of the active speech level S_{dB}(n) can be configured not to be allowed to go below the noise floor estimate N_{dB}(n).

### Gradient Index

The gradient index x_{gi} is defined as the sum of the signal gradient magnitude at each change of signal direction normalised by the frame energy and can be determined using the following equation:

$${x}_{gi} = \frac{{\sum }_{k = 2}^{{N}_{k} - 1} Ψ ( k ) \vert {S}_{nb} ( k ) - {S}_{nb} ( k - 1 ) \vert}{{\sum }_{k = 0}^{{N}_{k} - 1} {{S}_{nb} ( k )}^{2}} ,$$

where Nₖ is the frame index length and s_{nb} is the narrowband input signal, ψ(k) is equal to 1 when the gradient s_{nb}(k)−s_{nb}(k−1) changes sign and 0 otherwise. This value feature provides low values for voiced speech and high values for unvoiced speech. In other words generating a low value when the signal contains components when the vocal folds are vibrating (voiced).

In some embodiments other feature values suitable for predicting voiced or unvoiced characteristics of speech could furthermore be determined by the time domain feature calculator either in combination or to replace the gradient index value. Furthermore although in the above examples the determination of voiced or unvoiced speech is based on the time domain features, it would be understood that in some embodiments the determination could be performed based on at least one frequency domain feature.

The performance of calculating time domain features in shown in FIG. 4 by step 307.

In some embodiments the decoder 108 comprises a feature based attenuator 209. The feature based attenuator 209 can be configured to detect or determine, for example when the audio signal comprises voiced segments and generate an attenuation or amplification factor to be applied to the generated low band whenever the audio signal is lacking in voiced components. This operation is particularly useful as low band extension is useful only for voiced speech and adding energy to the low band during unvoiced or non-speech segments can be perceived as low frequency noise. The feature based attenuator 209 in some embodiments could be implemented as any suitable means for generating attenuator factors or attenuator gain determiner and could for example generate the attenuation factors or gains for the fundamental frequency determined or based factors or gains as well.

The feature based attenuator 209 can therefore be configured to receive feature values from the time domain feature calculator 205 to determine whether or not the current frame is voiced, non voiced speech or non-speech.

The feature based attenuator 209 can in some embodiments determine at least one attenuation factor for a frame based on the time domain feature values to control applications of the generated low band. The output of the low band synthesis process can then be modified by the at least one attenuation factor before generating the final output. In some embodiments, two attenuation factors can be generated by the feature based attenuator 209.

In some embodiments an ‘voiced’ attenuation factor g_{gi} can be determined based on the value of the gradient index feature x_{gi} by using fixed or determined threshold values. For example in some embodiments the attenuation factor g_{gi} can be set to be a value of 0 when the gradient index feature x_{gi} is greater than 5.0 and set to a value of 1 when the gradient index feature x_{gi} is less than 3.0 with a linear transition from 0 to 1 between these threshold values. However it would be understood than any suitable transition function can be implemented between such threshold values and similarly the threshold values themselves can in some embodiments be values other than those described above.

In some embodiments a pause attenuation factor gₚ can also be generated by the feature based attenuator 209. Where the current frame energy E_{dB}(n) does not exceed the noise floor estimate N_{dB}(n) by a determined value or amount, the generated pause attenuation factor can be configured to enable the low synthesis signal to be attenuated. In some embodiments, for example, the attenuation factor gₚ can be set to −40 dB where the frame energy and the noise floor estimate differ by less than 4 dB and the attenuation factor gₚ is set to 0 dB where the difference between the current frame energy and the noise floor estimate is greater than 10 dB with a linear transition on the decibel scale between these thresholds. It would be understood that the threshold values of 4 dB and 10 dB and also the linear transition between these thresholds can be any suitable value and function in some other embodiments.

In some embodiments the feature based attenuator 209 could alternatively implement the ‘pause’ attenuation factor by using a received external VAD (voice activity detector) signal. In some embodiments the VAD signal could be received from the speech decoder, that predicts whether the current frame contains speech or not.

These attenuation factors can then be passed to an attenuation amplifier 229.

The generation of at least one attenuation factor dependent on the time domain features of the narrowband signal is shown in FIG. 4 by step 311.

In some embodiments the decoder 108 can further comprise a Fast Fourier Transformer 207. The Fast Fourier Transformer 207 receives from the framer and windower 203 frequency domain analysis frame sample data and converts the time domain samples in each frame into suitable frequency domain values. For example in some embodiments the input signal to the Fast Fourier Transformer 207 is a series of frames, each 16 ms long with a frame shift of 10 ms having been windowed, for example using a Hamming window. The FFT 207 is then configured to transform the input signals into the frequency domain using, for example, a 128 point Fast Fourier Transform. The output frequency domain characteristics of the narrowband audio signal can then be passed in some embodiments to a filterbank 211. It would be understood that any suitable time to frequency domain transformer could be used in some embodiments of the application.

The operation of performing a Fast Fourier Transform is shown in FIG. 4 by step 309.

In some embodiments the decoder 108 further comprises a filterbank 211. The filterbank 211 can be configured to divide the frequency domain representation of the narrowband signal frame into sub-bands with linear spacing on a perceptually motivated mel-scale. The filterbank 211 can in some embodiments comprise a bank of 7 trapezoidal filters with the centre frequencies of each of the sub-bands located at 448 Hz, 729 Hz, 1079 Hz, 1515 Hz, 2058 Hz, 2733 Hz, and 3574 Hz.

It would be understood that in some other embodiments the filterbank can be any suitable filterbank with any suitable filter characteristics being performed on the frequency domain signal values.

In some embodiments the sub-band energies can then be calculated by squaring the magnitude of each of the sub-band frequency components amplitudes within each frequency bin generated by the filterbank.

In some embodiments the sub-band energies can be determined by squaring the magnitude of each FFT output to get the power spectrum, then for each sub-band, weight the squared frequency components by the corresponding filter window, before summing the weighted frequency components to get the sub-band energy.

In some embodiments the sub-band energy values can be log compressed using the mapping log (x+1).

The output of the spectral feature values can be passed to a low band predictor 215.

The operation of filtering and generation of spectral features is shown in FIG. 4 by step 313.

In some embodiments the decoder 108 comprises a fundamental frequency estimate corrector 213. The fundamental frequency estimator corrector 213 can be configured to receive the initial fundamental frequency estimate from the speech decoder 201 f₀ and produce a more accurate estimate of the fundamental frequency.

The fundamental frequency f₀ estimate from the audio signal can in some embodiments be determined for each input frame. For example as previously described, in some embodiments the speech decoder 201 can obtain as part of the adaptive multi-rate (AMR) speech codec decoder a pitch period estimate for f₀ that the speech decoder receives from the encoder. In some other embodiments the decoder can also determine the pitch period of the audio signal by any suitable pitch estimator of sufficient accuracy. In some embodiments, for example in speech or audio codecs which do not provide a fundamental frequency pitch period estimate, the fundamental frequency f₀ can be estimated from the narrowband input signal.

In some embodiments the fundamental frequency corrector 213 can be configured to perform an initial determination or decision on the consistency of the fundamental frequency estimate f₀. For example in some embodiments the f₀ corrector 213 can be configured to compare the current fundamental frequency estimate to a previous fundamental frequency estimate and furthermore evaluate the range of variation of fundamental frequency values within a determined number of previous frames. In some embodiments the fundamental frequency corrector 213 can be configured to generate an initial smoothed long term estimate or long term average of the fundamental frequency.

In some embodiments the long term average can be determined by using a first order recursive filter where the smoothed estimate can be updated in some embodiments dependent on whether or not the frame has been classified as being voiced or non-voiced. For example, in some embodiments the fundamental frequency corrector 213 can be configured to receive from the feature calculator 205 a value of the active speech level for the current frame to assist in determining whether or not the current frame is voiced or non-voiced. The fundamental frequency corrector 213 can thus using the feature based attenuation factors, the consistency of the fundamental frequency estimate and the comparison of the frame energy with the noise floor and the active speech level estimate perform a classification of the frame.

Short term octave errors can then be detected and corrected based on the assumption that the fundamental frequency contour is continuous.

In other words the fundamental frequency corrector 213 can be configured to double the fundamental frequency estimate, in other words the estimated f₀ is corrected to be 2f₀ when the current frame is classified as voiced speech, the corrected estimate is close to the previous frame fundamental frequency estimate and the corrected fundamental frequency estimate is closer to the long term fundamental frequency estimate.

Similarly the fundamental frequency corrector 213 can be configured to halve the fundamental frequency estimate, in other words the current estimate f₀ is corrected to 0.5 f₀ when the current frame is classified as voiced speech, the current frame corrected estimate 0.5 f₀ is closer to the previous frame fundamental frequency estimate and the corrected fundamental frequency estimate is close to the long term fundamental frequency estimate.

Furthermore other short term deviations in the fundamental frequency estimate can be allowed for in the fundamental frequency corrector 213 by replacing the estimated fundamental frequency f₀(n) by a corrected estimate from a previous frame f₀(n−1) when the current frame is classified as voiced, the current fundamental frequency deviates greatly from the previous frame fundamental frequency estimate, and the previous frame fundamental frequency estimate is closer to the long term estimate.

In some embodiments the fundamental frequency corrector 213 can be configured to perform such modifications to the fundamental frequency to a small number of successive frames only. In other words, should the fundamental frequency estimator corrector 213 determine that the correction has to be applied to a number of frames greater than a determined threshold then the fundamental frequency corrector performs a further change to re-correct or edit the fundamental frequency estimate values back to the original estimated value.

The fundamental frequency corrector 213 can furthermore output the corrected fundamental frequency values in some embodiments to a fundamental frequency estimate attenuation factor generator 219 and to the amplitude and phase calculator 221.

The decoder 108 in some embodiments can comprise a fundamental frequency attenuator generator 219. The fundamental frequency attenuator generator 219 is configured to generate at least one attenuation or gain factor that can be used to attenuate the artificial bandwidth extension low band output depending on the reliability of the fundamental frequency estimate. In other words where a highly variable fundamental frequency estimate is determined and considered not to be reliable (and therefore unlikely to be correct) the artificial bandwidth extension low band synthesis for such frames should be attenuated in order to prevent incorrect low band energy being heard by the user. The consistency or reliability of the fundamental frequency estimate can be determined by comparing the fundamental frequency estimate for the current frame against the estimate of at least one previous frame and evaluating the range of variation of fundamental frequency estimates. Where a small variation of fundamental frequency estimate is determined there is a high likelihood of consistent estimates.

The fundamental frequency attenuator generator can in some embodiments thus generate a binary attenuation factor g_{f0} to silence or mute the low band output when the fundamental frequency estimate f₀ is considered to be unreliable.

Furthermore “downward” octave errors in the fundamental frequency estimate have occasionally been observed especially when female speech, in particular where the voice is determined to be “creaky”. In order to reduce artefacts generated by these fundamental frequency error estimates the artificial bandwidth extension low band can be muted where the fundamental frequency estimate is lower than an adaptive threshold value. For example in some embodiments an updated long term estimate of fundamental frequency values f₀ can be calculated or determined from the corrected fundamental frequency f₀ values in frames classified as voiced speech. Furthermore a lower limit for an acceptable fundamental frequency is set at, for example 70% of the long term estimate and the fundamental frequency attenuator can generate an attenuation factor gₗ so that the low band output is muted when the current frame fundamental frequency estimate is below this limit.

In order that transitions are smooth, in some embodiments a transition range of a few Hz can be defined around the threshold from complete muting to no attenuation.

These attenuation factors can then be passed to an attenuation amplifier 229.

The determination of at least one fundamental frequency based attenuation factor is shown in FIG. 4 by step 321.

In some embodiments the decoder 108 comprises an artificial bandwidth extension low band energy predictor 215 or any suitable means for determining an estimated bandwidth extension energy level. The low band energy predictor 215 can be configured to produce an estimate of the low band energy required in order to synthesis the low band signal. In some embodiments the low band energy estimate can be determined or produced by using statistical techniques using training data derived from wideband speech recordings. In some embodiments the seven spectral feature values calculated from the narrowband input speech and output by the filterbank 211 can be used as an input to the low band energy estimator.

For example the training data can be any suitable speech database or part of speech database. An example database of speech is “SPEECON—speech database for consumer devices: database specification and validation” published in Proceedings of the Third International Conference on Language Resources and Evaluation (LREC), 2002, pages 329 to 333 by D. Iskra et al. Similarly any suitable training method can be implemented in some embodiments.

In some embodiments the speech database can be used to train the low band energy estimator by high pass filtering the database signals to simulate the input response of a mobile terminal and to generate a suitable narrowband training signal and scale the filtered values to a level of −26 dBoV. The filtered and scaled samples can then in some embodiments be coded and decoded using a suitable adaptive multi-rate (AMR) narrowband speech codec. The signals can then be split into frames and the associated spectral features as described earlier generated. For example the database signals a series of seven log compressed sub-band energy feature values as described earlier can be extracted and from these sub-band energy values the associated low band energy values stored also for later use. The lowband energy values are calculated from the same original signals but without highpass filtering in such embodiments as filtering would remove the lowband information. The lowband is not included in the 7 sub-bands that are used as input features.

In some other embodiments, other training samples can be processed in order to permit the low-band energy levels to be calculated. For example in some embodiments the speech samples can be scaled with an equivalent scaling factor as the samples for input feature calculation but without the use of a high pass filtering or adaptive multi-rate coding.

The associated low band energy values in some embodiments can be calculated through applying a 128 point Fast Fourier Transform (FFT) and using a trapezoidal filter window applied to the power spectrum to extract the low band energy from the database signals. The filter window in such embodiments can for example have a flat unit gain from 81 Hz to 272 Hz, with the trapezoid tail extending from 0 Hz to 81 Hz and 272 Hz to 385 Hz and the upper −3 dB point at 330 Hz. In such embodiments a logarithmic mapping of the form log (x+1) can be used to log compress the low band energy values.

In such embodiments a Gaussian mixture model (GMM) with ten components can be trained using the data from the database to model the joint probability distribution of the log compressed low band energy of a current frame, the log compressed sub-band energy features of the current frame and two proceeding frames. However it would be understood more than or fewer than ten components can be used in some embodiments. In other words: denoting the input spectral features (log-compressed sub-band energies) of the current frame and two preceding frames by x and the log-compressed lowband energy of the current frame by y the GMM models the joint distribution of x and y. The model can be used to estimate the log compressed low band energy from the input features using the minimum mean square error (MMSE) estimate. In other words the model can be used to get the MMSE estimate of y when having observed x.

In such embodiments the GMM predictor utilised in this example can be similar to those described for high band artificial bandwidth extension. Although this example describes the implementation of the low band prediction energy estimate being formed using a Gaussian mixture model, any suitable pattern recognition model or modelling function or means could be implemented, for example a neural network or a Hidden Markov Model (HMM). Furthermore although the features used as an input feature set are those of the spectral features generated from the filterbank 211 any suitable input feature set could be used in addition to or to replace the spectral features used in this example.

In some embodiments the energy estimates are calculated for every 10 ms frame and a linear interpolation between two successive estimates can be used to generate an estimate for every 5 ms sub-frame. In such embodiments where the spectral features and thus lowband energy estimates are determined every 5 ms no interpolation operation is required.

The output of the Gaussian mixture model predictor y(n) for frame n can then be converted to the energy estimate E_{lb}(n) by reversing the log compression E_{lb}(n)=e^{y(n)}−1.

The output of the low band energy predictor 215 can be passed to a harmonic amplitude estimator 217.

The operation of determining the low band energy estimate is shown in FIG. 4 by step 315.

In some embodiments the decoder 108 comprises a harmonic amplitude estimator 217 or means for determining a harmonic shaping function. The harmonic amplitude estimator 217 is configured to determine or generate estimates of the amplitudes of the artificial bandwidth extension low band harmonics dependent on the low band energy estimate. As conventional low band determinations have occasionally produced short peaks of high or too high values which can be heard as momentary artefacts, the harmonic amplitude estimator 217 can perform an adaptive compression of the low band energy estimates.

Furthermore in some embodiments the harmonic amplitude estimator 217 can apply a logarithmic compression curve to the energy estimates that exceed the smoothed contour by greater than a determined amount. For example in some embodiments the logarithmic compression can be applied to energy estimates which exceed the smoothed contour by a factor greater than 150%.

The sinusoidal components or single frequency components in the low band are generated in some embodiments up to a frequency of 400 Hz. In some embodiments the harmonic amplitude estimator generates an indicator or range of harmonic indicators whereby initially all of the harmonics to be generated have equal amplitudes. The amplitude of the sine waves generated in the synthesis generator is set such that the energy estimate of the low band is approximately realised. For example the harmonic amplitude estimator can generate an amplitude using the following equation:

$${A}_{e} = \sqrt{{kE}_{lb} ( n ) ( \frac{{f}_{0}}{330 Hz} - 0.5 )} ,$$

where Aₑ is the amplitude, the constant k represents the effects of windowing, Fast Fourier Transform and filtering in the computation of the low band energy such that a single sine wave with the amplitude \sqrt{kE_{lb}(n)} can yield the low band energy of E_{lb}(n). The term in brackets can adjust the amplitude such that the total energy of the harmonics generated in the low frequency extension band approximately matches the estimated low band energy.

However in some embodiments the harmonic amplitude estimator 217 can then be configured to apply a frequency dependent attenuation or generate an attenuation profile or function so to provide a smooth transition from the low frequency extension band to the telephone band. The profile or function can be passed in some embodiments to the synthesis amplitude calculator.

The generation of the harmonic amplitude profile is shown in FIG. 4 by step 317.

In some embodiments the decoder comprises an input amplitude and phase calculator 221.

The input amplitude and phase calculator 221 or means for determining at least one amplitude value and phase value dependent on a first audio signal in some embodiments determines an amplitude for the artificial bandwidth extension low band which is dependent on the fundamental frequency estimate and the low band analysis framed narrowband audio signal (the first audio signal). This is because the number of harmonic components within the low band can vary dependent on the fundamental frequency.

The input amplitude and phase calculator in some embodiments analyses the input narrowband signal in 5 ms steps using a segment length of 20 milliseconds and a look ahead of 5 ms, where each segment has been windowed with a Hann window. The amplitude and phase at the frequency of each multiple of the estimated fundamental frequency can then be analysed, according to the following equation:

$$S ( n , l ) = {\sum }_{m = 0}^{N - 1} {S}_{n , w} ( m ) {e}^{- 2 π i \frac{l {f}_{0}}{{f}_{s}}} ,$$

where N is the length of the segment to be analysed, S_{n,w} is the windowed signal segment for frame n and f_{S} is the sampling frequency. In other words, this analysis can be considered to be a Discrete Fourier Transform of the input signal computed for only a few specific frequencies lf₀(n) below 400 Hz. In some other embodiments a computation of Fast Fourier Transform of sufficient lengths that the frequency bins corresponding to the harmonic frequencies can be extracted can be implemented.

In such embodiments the input amplitude and phase calculator 221 can then generate an amplitude for the l'th harmonic in the input signal as:

A(n,l)=c_{A}|S(n,l)|,

where C_{A} is a constant which compensates for the effects of the segment length and windowing such that A(n,l) represents the amplitude of the partial.

The input amplitude and phase calculator can then pass the “A” value to the synthesis amplitude calculator 223 for further processing.

The input amplitude and phase calculator 213 can furthermore generate an observed phase of the l'th harmonic for-frame n of the input signal using the following equation:

(n,l)=arg(S(n,l)),

where arg is the argument of the value The observed phase values can then be passed to the synthesis phase calculator 225.

The operation of generating an initial or observed amplitude and phase value is shown in FIG. 4 by step 323.

In some embodiments the decoder 108 comprises a synthesis amplitude calculator 223, or means for synthesizing a further amplitude value. The synthesis amplitude calculator is configured to receive the input amplitude estimate, harmonic amplitude estimate and corrected f₀ estimate and determine at least one single frequency component or sinusoid amplitude value.

Thus in some embodiments the synthesis amplitude calculator 217 uses a first order recursive filter to smooth the fundamental frequency estimates for consecutive frames and thus reduce a rapid variation of sine wave amplitudes.

As described previously the output of the low band predictor 215 generates a single low band energy estimate produced from the predictor (such as the Gaussian mixed model predictor). Furthermore all of the low band harmonic partials can be determined or generated with equal amplitudes such that the energy estimate is approximately realised. This approach has been evaluated by replacing the low band harmonics of a wideband speech signal by sinusoidal or single frequency components with correct frequencies but using the amplitude of the first partial for all low band harmonics. In such embodiments during informal listening evaluations, only a slight difference was noticed in comparison to a signal with correct frequencies and amplitudes of low band harmonics.

In some embodiments, frequency dependent attenuation can be applied to the amplitudes A to provide a smooth transition from the extension band to the telephone band. In principle, the synthesis low band signal can smoothly extend the spectrum of the telephone band signal. However in practice, the detailed low cut characteristics of the telephone connection are generally unknown and can vary largely from case-to-case. In such embodiments the low band synthesis should ideally be adjusted to the frequency characteristics of the narrowband signal but can in some embodiments and for simplicity use a fixed transition.

In such embodiments the upper end of the extension band can apply a gradual transition from the extension band to the telephone band by limiting the synthesis amplitudes relative to the observed amplitudes of the harmonics. Thus in some embodiments the amplification of observed harmonics is limited between 250 Hz and 400 Hz using a smooth curve that approaches infinity at 250 Hz and approximately 10 dB at 300 Hz and 0 dB at 400 Hz. However it would be appreciated that any suitable filtering approach could be implemented.

In some embodiments the synthesis amplitude calculator can further take into account the observed low band harmonics of the input signal when synthesising the low band such that the sum of the input signal and synthesised signal approximately produces the estimated amplitude for the harmonic partials. The amplitude for the synthesis of each harmonic is computed, for example by subtracting the observed harmonic amplitude from the limited target amplitude if the target amplitude exceeds the observed amplitude. For example where the observed amplitude is larger, no synthetic signal is generated.

Furthermore in some embodiments the input amplitude and phase calculator 221 can apply a smoothing filter to the harmonic amplitudes to reduce the rapid variation in the extension band signal.

In some embodiments the decoder 108 comprises a synthesis phase calculator or means for synthesising a further phase value. The synthesis phase calculator 225 can be configured to receive an initial phase observation from the input amplitude and phase calculator and further receive a fundamental frequency estimate from the fundamental frequency corrector 213. The synthesis phase calculator 225 can use the observed phase from the input signal when it is considered to be reliable and consistent.

The harmonics may be attenuated in the input signal (due to the transmission chain or the transmitting device, for example) but the phase information can be detected reliably. In such embodiments it can be beneficial to use the observed phase to maximise the quality of the output signal. However in these embodiments if or when the phase of the frequency of the l'th harmonic is lost due to the speech transmission chain generating a continuous phase from frame-to-frame can be implemented.

A reference phase value φ_{ref}(n,l) can thus be generated by the synthesis phase calculator 225 using harmonic values for each frame n and harmonic l from the previous synthesis phase values \tilde{φ}(n−1,l) using the estimates of the fundamental frequency for the previous and current frames f₀(n−1) and f₀(n) and assuming phase continuity at the frame boundary in the middle of the overlapping region. The difference δ(n,l) between the observed phase and reference phase can be calculated according to the following equation:

δ(n,l)=φ(n,l)−φ_{ref}(n,l)

and wrapped to the range −π to +π. Furthermore in some embodiments the synthesis phase calculator 225 can determine the difference between successive values of the difference δ(n,l) according to the following equation:

Δδ(n,l)=δ(n,l)−δ(n−1,l)

which can also be wrapped within the range −π to +π.

The synthesis phase calculator 225 can then apply a series of following rules within which the synthesis phase of the l'th harmonic in each frame n can be determined by the first matching condition of the following list. In other words the synthesis phase calculator or means for synthesising a further phase value associated with each phase value can therefore be considered to comprise in at least one embodiment a condition determiner or means for determining a condition associated with each phase value; and also a further phase generator or means for generating a further phase value dependent on the condition and the phase value.

Therefore the synthesis phase calculator 225 is configured to perform the following operation in order 1-5 and set the phase on finding a first matching operation.

1. When the observed phase of the l'th harmonic is highly varying, the observed phase information in the frequency range of this harmonic is considered unreliable and a continuous phase contour is generated for synthesis. For example in some embodiments the phase variability can be assessed by generating an expected phase angle φₑ(n,l) which can be determined from the observed phase φ(n−2,l) and the estimated fundamental frequency values f₀(n−2), f₀(n−1), and f₀(n). A phase error between the expected and observed phase φₑ(n,l)−φ(n,l) can then be determined wrapped within the range −π to +π and smoothed in time using a recursive filter. In such embodiments the current value of the smoothed phase error is compared with a fixed threshold value. When the threshold is exceeded, the phase is considered to fluctuate too wildly and the continuous phase contour is used. In other words in some embodiments the output synthesis phase is determined as:

\tilde{φ}(n,l)=φ_{ref}(n,l)

2. In some embodiments on signal onset the observed phase can be implemented or used. In such embodiments the low band energy estimate is compared against its smoothed copy from the previous frame or frames other than the current frame. For example in some embodiments the synthesis phase calculator determines when the previous energy estimate has a low relative value and the current value has a sufficiently high relative value to use the observed phase value. In other words:

\tilde{φ}(n,l)=φ(n,l)

3. In some embodiments the synthesis phase calculator can be configured such that when the phase mismatch between the observed phase and the continuous reference phase is small then the observed phase is used. In some embodiments this difference within which the observed phase is used can be 718. In which the synthesis phase calculator outputs the following:

\tilde{φ}(n,l)=φ(n,l)

4. In some embodiments the synthesis phase calculator can determine when there is a mismatch between the observed phase and reference values but the observed phase is consistent in successive frames then the observed phase is approached gradually. For example the synthesis phase calculator 225 can determine when:

$${max}_{j = 0 … 3} \vert Δ δ ( n - j , l ) \vert < \frac{π}{8} ,$$

and then generate an output phase of:

$$\tilde{ϕ} ( n , l ) = {ϕ}_{ref} ( n , l ) \pm \frac{π}{8} ,$$

where the sign is chosen such that the output phase \tilde{φ}(n,l) is closer to φ(n,l) than φ_{ref} (n,l).
5. In some embodiments the synthesis phase calculator 225 can be configured to output the reference phase when determining that the observed phase of the harmonic partial in question is inconsistent from frame-to-frame. In other words outputting a low band synthesis value based only on the criteria of the phase continuity at the frame boundary. Thus the synthesis phase calculator 225 in such embodiments can output the following phase value:

\tilde{φ}(n,l)=φ_{ref}(n,l)

The operation of generating at least one synthesised phase value, each associated with a synthesised harmonic, is shown in FIG. 4 by step 327.

In some embodiments the decoder comprises a sine synthesiser 227. The sine synthesiser can receive the outputs of the synthesis amplitude calculator 223, the synthesis phase calculator 225 and also the corrected fundamental frequency estimate from the fundamental frequency corrector 213 and generate the artificial bandwidth extension from the harmonics formed from sinusoidal signal (or as seen from the frequency domain single frequency component). In some embodiments this can be represented by the following equation:

$${S}_{s} ( n , k ) = {\sum }_{l}^{ } \tilde{A} ( n , l ) cos ( 2 π π \frac{{lf}_{0} ( n )}{{f}_{s}} + \tilde{ϕ} ( n , l ) ) ,$$

where k is the time index within the frame n, l is the index of the harmonic from f₀ up to 400 Hz where the number of harmonics being determined by the value of f₀.

The output signal can then be passed to an attenuator amplifier 229.

The generation of the synthesized artificial bandwidth signal is shown in FIG. 4 by step 329.

The attenuation amplifier 229 can receive the output from the sinusoidal synthesiser 227 and the attenuation factors from the time domain attenuator 209 and the fundamental frequency based attenuator 219 to generate an attenuated or amplified, in other words synthesised frames are then multiplied by the attenuation factors g_{gi}, gₚ, g_{f0}, and gₗ. The output of the attenuation amplifier 229 can then be passed to the overlap adder 231.

The operation of performing the attenuation amplification is shown in FIG. 4 by step 331.

In some embodiments the decoder 108 comprises an overlap adder 231 configured to window the output artificial bandwidth extension low band signal with a 10 ms Hann window and add overlaps to get a continuous low band signal with smooth transitions between adjacent frames. The output s_{lb} can then be passed to the full band summer configured to receive both the narrowband s_{nb} and band extension s_{lb} and output a full band signal sₒᵤₜₚᵤₜ. The full band addition is shown in FIG. 4 by step 335.

In such embodiments the low band extension can be determined by using existing signals at narrowband frequencies and adapting to different passband characteristics closer to the lower end of the telephone band. The algorithmic delay of such an embodiment is relatively low (a few ms in addition to the framing delay) and furthermore by combining the low band bandwidth extension with artificial bandwidth extension to frequencies above the telephone band, a more balanced and natural speech spectrum can be developed than using the narrowband signal. In other words by using both low band and high band artificial bandwidth extension, a total bandwidth which is close to the bandwidth of wideband telephone speech transmitted by an adaptive multi-rate wideband codec (AMR-WB) can be achieved.

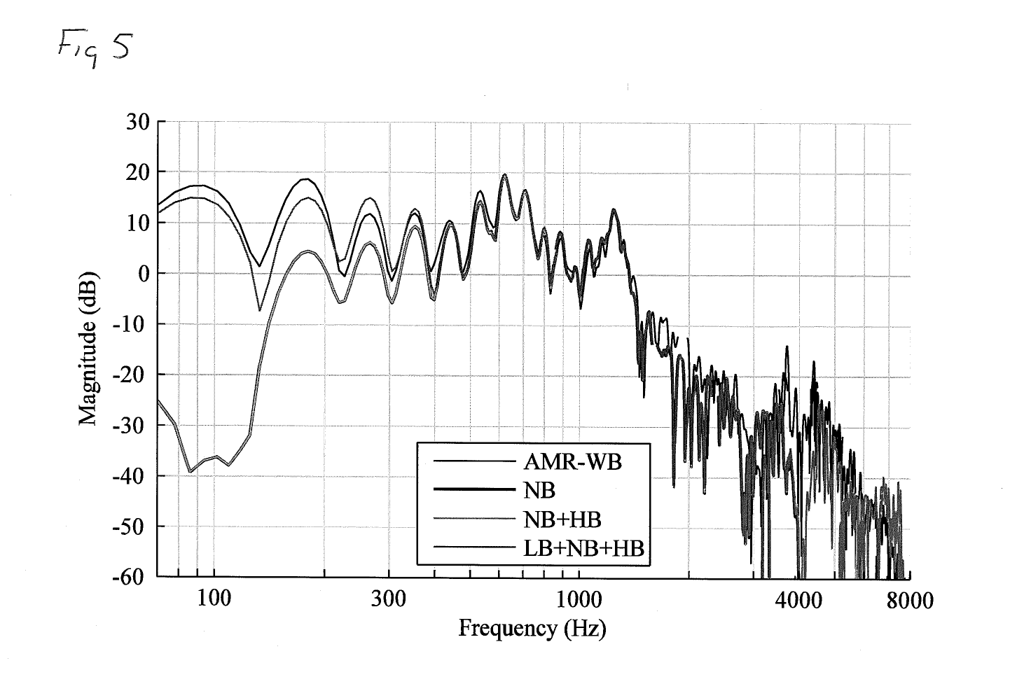

For example as shown in FIGS. 5, 6 and 7, a series of simulated bandwidths are shown for the adaptive multi-rate wideband codec, a narrowband codec, a narrowband plus high band artificial bandwidth extension and a narrowband with both low band and high band artificial bandwidth extension are shown.

FIG. 5 for example shows the relative performance for narrowband, adaptive multi rate-wide band, high band artificial bandwidth extension, and low band+high band artificial bandwidth extension for a voiced male speech short segment example wherein the lowband artificial bandwidth extension simulated signal performance is significantly improved over the narrowband signal.

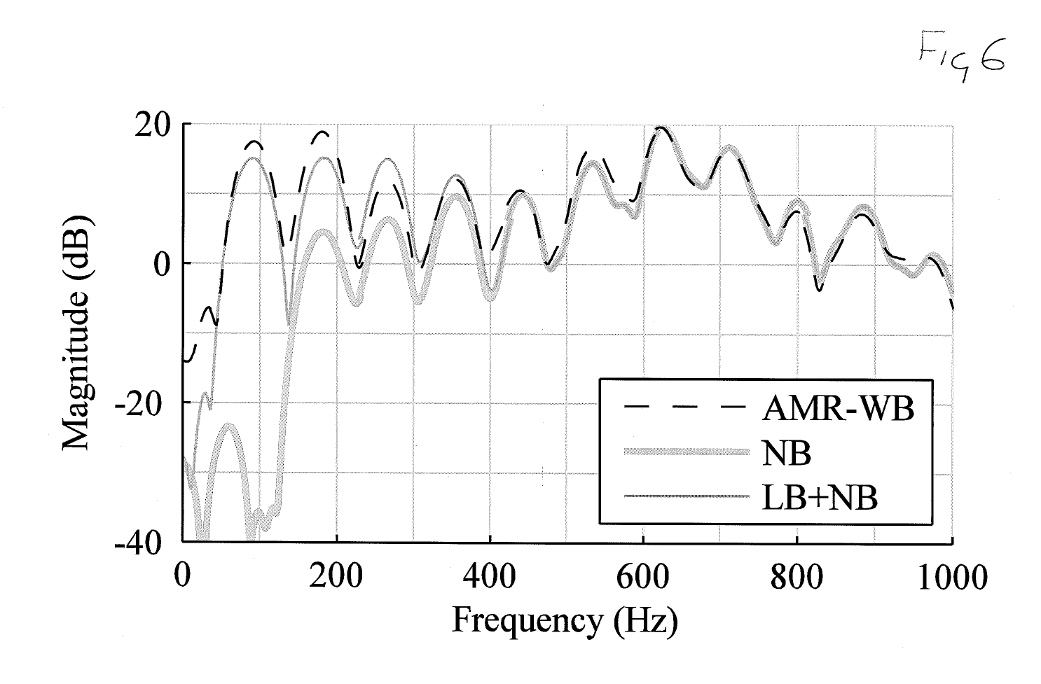

FIG. 6 furthermore shows the relative performance for narrowband, Adaptive Multi-Rate Wideband, and low band extension+narrowband for the voiced male speech example shown in FIG. 5, further demonstrating that lowband extension performs only slightly worse than the AMR-WB codec.

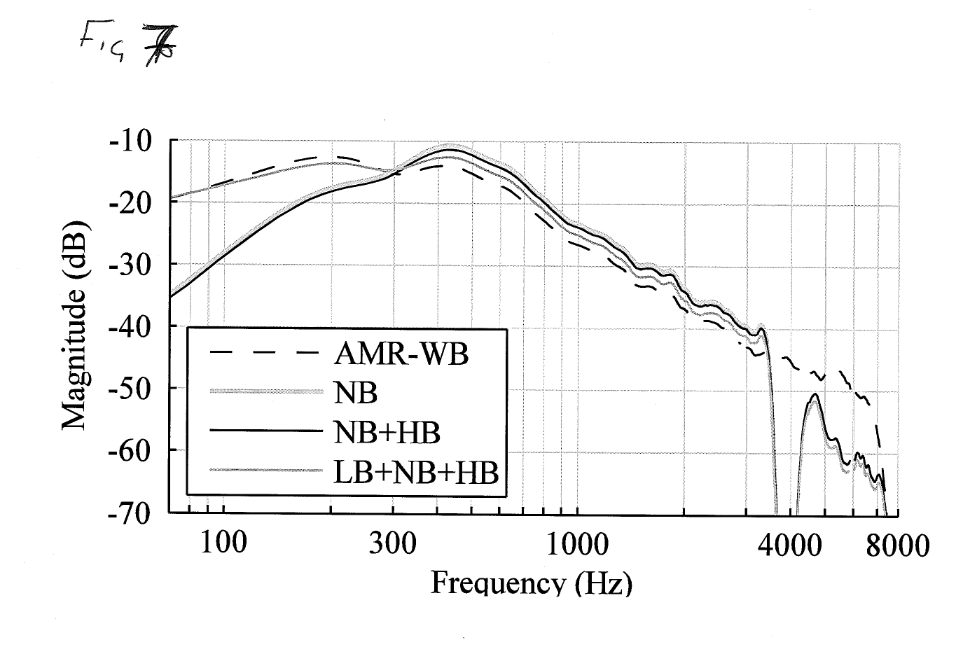

FIG. 7 shows a further example of the relative performance characteristics in long-term average spectra shown by narrowband, adaptive multi-rate wideband speech coding, and artificial bandwidth extension decoding where once again the lowband artificial bandwidth extension performance is significantly better than narrowband and only slightly worse than AMR-WB.

Although the above examples describe embodiments of the invention operating within a codec within an electronic device 10 or apparatus, it would be appreciated that the invention as described below may be implemented as part of any audio decoding process. Thus, for example, embodiments of the application may be implemented in an audio decoder which may implement lowband artificial bandwidth extension.

Thus user equipment may comprise a bandwidth extender such as those described in embodiments of the invention above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

Therefore in summary at least one embodiment of the invention comprises an apparatus configured to: determine at least one amplitude value and phase value dependent on a first audio signal; synthesize a further amplitude value associated with each amplitude value dependent on a determined harmonic shaping function; synthesize a further phase value associated with each phase value; and generate a bandwidth extension signal dependent the further amplitude value and the further phase values.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-62. (canceled)

63. Apparatus comprising:
an input amplitude and phase calculator configured to determine at least one amplitude value and phase value dependent on a first audio signal;
a synthesis amplitude calculator configured to synthesize a further amplitude value associated with the at least one amplitude value;
a synthesis phase calculator configured to synthesize a further phase value associated with the at least one phase value; and
a signal synthesizer configured to generate a bandwidth extension signal dependent the further amplitude value and the further phase values.

64. The apparatus as claimed in claim 63, further comprising an attenuator gain determiner configured to generate at least one attenuation factor, wherein the bandwidth extension signal is further dependent on the attenuation factor.

65. The apparatus as claimed in claim 64, wherein the at least one attenuation factor comprises an unvoiced signal attenuation factor, the unvoiced signal attenuation factor being dependent on an unvoiced component of the first audio signal.

66. The apparatus as claimed in claim 64, wherein the at least one attenuation factor comprises a pause attenuation factor, the pause attenuation factor being dependent on a determined paused speech component of the first audio signal.

67. The apparatus as claimed in claim 64, wherein the at least one attenuation factor comprises a fundamental frequency attenuation factor, the fundamental frequency attenuation factor being dependent on a fundamental frequency estimate associated with the first audio signal.

68. The apparatus as claimed in claim 64, wherein the at least one attenuation factor comprises an octave error attenuation factor, the octave error attenuation factor being dependent on a determined error in a fundamental frequency estimate associated with the first audio signal.

69. The apparatus as claimed in claim 63, further comprising a harmonic amplitude estimator configured to determine a harmonic shaping function and the synthesized further amplitude value being dependent on the determined harmonic shaping function.

70. The apparatus as claimed in claim 69, further comprising a lowband energy estimator configured to determine an estimated energy level of the bandwidth extension signal.

71. The apparatus as claimed in claim 70, wherein the lowband energy estimator comprises:
a feature determiner configured to determine at least one feature value associated with the first audio signal; and
a trained modelling function configured to determine the estimated energy level of the bandwidth extension signal dependent on the at least one feature value.

72. The apparatus as claimed in claim 71, wherein the trained modelling function comprises at least one of:
a Gaussian mixture model;
a hidden Markov model; and
a neural network model.

73. The apparatus as claimed in claim 63, wherein the signal synthesizer configured to generate a bandwidth extension signal being further dependent on the first audio signal.

74. The apparatus as claimed in claim 73, further comprising:
an amplitude determiner configured to determine the amplitudes of the first audio signal for the harmonic frequencies associated with the first amplitude; and wherein the synthesizer being configured to determine the further amplitude value dependent on the amplitudes of the first audio signal for the harmonic frequencies associated with the first amplitude.

75. The apparatus as claimed in claim 63, wherein the synthesis phase calculator comprises:
a condition determiner configured to determine a condition associated with the at least one phase value;
a phase synthesizer configured to generate the further phase value dependent on the condition and the at least one phase value.

76. The apparatus as claimed in claim 75, wherein the condition determiner comprises at least one of:
a first condition determiner configured to determine the at least one phase value is varying, wherein the further phase value is a reference phase value;
a second condition determiner configured to determine an onset of the at least one phase value, wherein the further phase value is the reference phase value;
a third condition determiner configured to determine the at least one phase value is close to the reference phase value, wherein the further phase value is the at least one phase value;
a fourth condition determiner configured to determine the at least one phase value is different from the reference phase value and the at least one phase value is consistent over a period of time, wherein the further phase value is approaching the at least one phase value from the reference phase value; and
a fifth condition determiner configured to determine the at least one phase value is inconsistent over a period of time, wherein the further phase value is the reference phase value.

77. The apparatus as claimed in claim 76, wherein the reference phase value is dependent on the further phase value from a previous period and at least one estimate of the fundamental frequency for the previous and current periods.

78. The apparatus of claim 63 is comprised in at least one of: a chipset, an electronic device.

79. A method comprising:
determining at least one amplitude value and phase value dependent on a first audio signal;
synthesising a further amplitude value associated with the at least one amplitude value;
synthesising a further phase value associated with the at least one phase value; and
generating a bandwidth extension signal dependent the further amplitude value and the further phase values.

80. The method as claimed in claim 79, further comprising generating at least one attenuation factor, wherein the bandwidth extension signal is further dependent on the attenuation factor.

81. The method as claimed in claim 79, wherein synthesising a further phase value associated with the at least one phase value comprises performing:
determining a condition associated with the at least one phase value;
generating a further phase value dependent on the condition and the at least one phase value.

82. The method as claimed in claim 81, wherein determining the condition associated with the at least one phase value comprises at least one of:
determining the at least one phase value is highly varying, wherein the further phase value is a reference phase value;
determining the onset of the at least one phase value, wherein the further phase value is the reference phase value;
determining the at least one phase value is sufficiently close to the reference phase value, wherein the further phase value is the at least one phase value;
determining the at least one phase value is different from the reference phase value and the at least one phase value is consistent over a period of time, wherein the further phase value is approaching the at least one phase value from the reference phase value; and
otherwise determining the at least one phase value is inconsistent over a period of time, wherein the further phase value is the reference phase value.
